(19) United States
(12) Patent Application Publication
(10) Pub. No.: US 2002/0035969 A1
(43) Pub. Date: Mar. 28, 2002

(54) Method and a device for producing a fuel mixture for a combustion system

(76) Inventors: Rudolf Thaler, Rechberghausen (DE); Karlheinz Matheusser, Heuchlingen (DE)

Correspondence Address: William A. Drucker, 1299 Pennsylvania Ave., N.W., Washington, DC, 20004, US

(21) Appl. No.: 09/917,843

(22) Filed: Jul. 26, 2001

(30) Foreign Application Priority Data
Jan. 28, 1999 (DE) 199 03 257.2

(51) Int. Cl. F02B 47/00

(52) U.S. Cl. 123/25 E; 123/25 A

(57) ABSTRACT

The invention relates to a method for producing a pure mixture comprising fuel, water and an emulsifier for a combustion device. According to the method, a mixture pump located in a fuel circuit ensures that a volume of the fuel mixture used by the combustion device is constantly replaced with an identical volume of fuel, water and emulsifier. The quantity of water and emulsifier added to the mixture and consequently, the mix ratio of the components in the fuel mixture, is metered according to the fuel volume flow of fuel that is drawn from the fuel tank by the mixture pump, as metered by a metering device. The method guarantees for less operation and does not necessitate any intervention in existing control systems for the combustion device. A device for carrying out the method can be constructed simply by fitting an add-on device into an existing fuel circuit.

### RELATED APPLICATIONS

This application is a continuation-in part-application of international patent application serial number PCT/EP99/09278 filed on Nov. 29, 1999 and claiming priority of German patent application serial number 199 03 257.2 filed on Jan. 28, 1999.

### RELATED PRIOR ART

The invention relates to a method and to a device for producing a fuel mixture consisting of fuel, water and an emulsifying agent for a combustion device. The invention further relates to an add-on set for producing a fuel mixture containing fuel, water and an emulsifying agent, the add-on set being suitable for a subsequent installation in an existing fuel circuit of a combustion device.

It has been known for quite a time to add water to organic fuels for combustion engines, in particular diesel fuel, in order to reduce fuel consumption and to make exhaust pollutants less polluting. To improve the miscibility of water and fuel, an emulsifying agent can be added, which reduces the interfacial tension between the water drops and the fuel drops.

A method for producing a mixture of diesel fuel and water is known from U.S. Pat. No. 5,904,121, in which diesel fuel and water from a diesel tank and from a water tank are drawn by a fuel pump and mixed with each other in a mixer. The fuel mixture arrives in a fuel circuit, from which a fuel collector takes off a part of the mixture and supplies same to a combustion engine. The remaining part of the mixture is temporarily stored in a surplus container, which is arranged behind the fuel collector. A control device controls the fuel pump and a shut-off valve, which is arranged in the suction line leading to the water tank, dependent on a plurality of engine parameters as e.g. speed and engine temperature. The mixture ratio between diesel fuel and water is substantially determined by the geometry of the mixer. The real mixture of the two components to form a homogenous mixture, however, takes place not before the fuel pump arranged in the fuel circuit.

A method is known from WO 98/13596, in which the water share of a mixture of fuel and water stored in a tank is further increased by adding water. In this method, a pump carries the mixture out of the tank into a fuel circuit. There, the mixture is mixed again in a mixer and then supplied to the combustion engine, which takes off the amount of fuel mixture it requires from the fuel circuit. From a water tank, additional water is supplied to the fuel line leading to the fuel circuit. The amount of water added in that way is calculated on certain engine parameters and/or on the output of the pump.

### SUMMARY OF THE INVENTION

It is an object of the invention to disclose a method and a device for producing an improved fuel mixture containing fuel, water and an emulsifying agent for a combustion system. It is a further object of the invention to disclose a method and a device of the aforementioned kind which are reliable and allow a trouble-free operation of the combustion system.

It is a further object of the invention to disclose an add-on set for producing a fuel mixture containing a fuel, water and an emulsifying agent, the add-on set being suitable for a subsequent installation in an existing fuel circuit of a combustion system, in which a fuel pump is arranged generating a constant fuel volume flow for circulating the fuel in the fuel circuit, and a tapping means is arranged for tapping fuel from the fuel circuit and for feeding the tapped fuel to a consumer.

The add-on set shall allow a trouble-free operation of the combustion system and shall be easily installed in an existing system.

These and other objects are achieved by circulating the fuel mixture in a fuel circuit by means of a fuel pump, which generates a preferably constant fuel mixture volume flow. At a tapping means fuel mixture is tapped from the fuel circuit and supplied to a consumer. Due to the vacuum arising from the take-off of fuel mixture, at a feed line arranged downstream with respect to the tapping means and before the fuel pump, fuel is drawn from a fuel tank connected to the feed line and is supplied to the fuel circuit. The volume flow drawn from the fuel tank and supplied to the fuel circuit is metered with a metering device. Dependent on the fuel volume flow metered by the metering device, water and emulsifying agent are added to the supplied fuel or to the fuel mixture circulating in the fuel circuit.

The aforementioned and other objects are further achieved by providing:

a fuel pump, producing a preferably constant fuel mixture volume flow, for circulating the fuel mixture in the fuel circuit;

a tapping means for tapping fuel mixture from the fuel circuit and feeding the fuel mixture which was taken off to a consumer;

a feed line arranged downstream behind the tapping means and in front of the fuel pump, for feeding fuel from a fuel tank connected to the feed device into the fuel circuit;

a metering device for metering the volume flow of the fuel being supplied from the fuel tank into the fuel circuit.

The device further comprises:

a mixer for admixing water and emulsifying agent and

a control device for controlling the amount of water and emulsifying agent admixed in the mixer dependent on the fuel volume flow metered by the metering device.

In view of the add-on set, the objects of the invention are achieved by a device which comprises:

a mixer for admixing fuel, water and an emulsifying agent;

a water tank, from which water can be supplied into the mixer;

an emulsifying agent tank, from which an emulsifying agent is suppliable to the mixer;

a feed line arranged downstream behind said tapping means and before the fuel pump, for feeding fuel into the fuel circuit from a fuel tank to be connected to the feed line;

a metering device for metering the volume flow of the fuel supplied from the fuel tank into the fuel circuit;

a control device for controlling the amount of water and emulsifying agent admixed in the mixer, dependent on the fuel volume flow metered by the metering device.

The method of the invention allows the amount of fuel, water and emulsifying agent to be equal to the amount of fuel mixture tapped at the tapping means. This compensation is done completely on its own, i.e. without external control. If, namely, only a part of the fuel mixture that was taken off was replaced, it would gradually result in a complete emptying of the fuel circuit. This, however, is not possible in a fuel pump producing a constant fuel mixture volume flow.

By controlling the addition of water and emulsifying agent dependent on the metered volume flow of the supplied fuel, it is ensured, in a very simple way, that the addition of fuel, water and emulsifying agent is always done in the mixture ratio desired.

The self-regulation of the total amount of the supplied mixture is, thus, finally, due to the vacuum produced at the suction side, while the control device coacting with the metering device is responsible for keeping the desired mixture ratio of the supplied mixture.

The method of the invention has the advantage that it can be accomplished on the basis of an existing fuel circuit, which is modified by inserting an add-on set. When being inserted, the existing fuel circuit is merely cut open at three spots and, there, is connected to suitable connections of an add-on set. The control device of the add-on set requires, at least when a constant mixture ratio is desired, no data from the control of the existing fuel circuit or from a central control of the combustion engine. Thus, complicated and failure-prone interventions into the existing control systems are not necessary.

The method of the invention is indeed also advantageous, when the method is not accomplished by means of a fuel circuit being improved with an add-on set, but when the fuel circuit is designed and constructed from the beginning according to the invention. The control device can then be, for example, a part of a central control of the combustion engine. Due to metering the fuel which was really supplied to the fuel circuit, it is deductible in a particular simple way, which amounts of emulsifying agent and water are to be added to obtain the desired mixture ratio of fuel mixture. In known methods of that kind, however, the amount of the added water is always determined on the basis of a plurality of other parameters, e.g. based on the performance of the fuel pump or certain operation parameters of the combustion engine like speed, temperature etc. This is not only more effort, but also less exact and does, thus, not allow the keeping of the desired mixture ratio.

The method of the invention does not exclude, however, to modify the mixture ratio as such as a function of other parameters. It is possible, for instance, to provide the control device with a temperature sensor. In that way, the mixture ratio can be modified dependent on the temperature in the ambiance of the combustion engine, which can make sense, for example, when there is a cold start of the combustion engine. In particular, when the control device is part of a central control of the combustion engine, it is the obvious thing to utilize cooling water temperature, which is usually metered, anyway, as a basis for this purpose. Moreover, other dependencies besides a temperature dependency of the mixture ratio can be taken into account without problems.

The method of the invention and the device of the invention allow a trouble-free operation of a combustion engine with an addition of up to approximately 50 vol.-% of water, wherein with an addition of approximately 30 vol.-% of water practically no deterioration in power occurs.

In a preferred embodiment of the invention, the volumes of the water and of the emulsifying agent admixed per time unit are proportional to the fuel volume flow metered, so that the ratio of fuel, water and emulsifying agent is constant in said fuel circuit. Such a proportional admixture of water and emulsifying agent allows a very simple design of the control device, and engagements in existing control systems can be completely omitted. Experiments have disclosed that a constant mixture ratio is, to a large extent, independent of the load of the combustion engine and results in favorable values in consumption and exhaust gases.

According to a preferred improvement, per volume unit of supplied fuel approximately 0.2 to 0.4 volume units of water and approximately 0.005 to 0.015 volume units of emulsifying agent are added. It has been shown that, with these values, in commonly used combustion engines, a trouble-free operation with particularly low consumption values and favorable exhaust gas characteristics can be reached.

In another preferred embodiment of the invention the addition of water and emulsifying agent is performed via an injection valve respectively, wherein at least after exceeding a minimum temperature at each injection operation a predetermined single liquid volume is injected into the mixer. This way of adding has, in comparison to a continuous addition, the advantage that instead of a complicated analog valve control a simple cycle control can be used. Beneath the minimum temperature, the injected liquid volumes may differ from each other, as the viscosities of water and emulsifying agent have different temperature dependencies.

In a preferred improvement, the liquid volume injected in each injection operation is approximately 0.4 ml to 0.8 ml. It has been shown that in injection volumes in this range the application of sufficiently robust injection valves is possible and, nevertheless, a sufficiently fine dosing can be reached.

In the application of injection valves it is preferred to hold the number of injection operations per time unit proportional to the fuel volume flow metered. Such a proportional control results in a constant ratio of fuel, water and emulsifying agent in the fuel circuit and is, from the control point of view, very easy to realize.

Preferably, the water and the emulsifying agent are, respectively, supplied to the injection valves for the water and the emulsifying agent via a pump which produces a constant pressure. Because of the pressure constancy, it is guaranteed that really the same amount of liquid is injected at each opening of the injection valves.

Experiments have shown that a particularly favorable injection behavior can be reached, if the pressure produced by the pumps respectively for the water and the emulsifying agent is at least 1.5 bars and preferably between approximately 7 and 9 bars.

According to a preferred improvement, at least one of the pumps for the water and the emulsifying agent is switched off, if the period between two injection operations exceeds a predetermined threshold. In that way, it is ensured that the pumps do not, unnecessarily, generate pressure and, in doing so, possibly run hot. The control of the pumps and of the injection valves has to be constructed in such a way that, before a new injection operation, the respective pump restarts in time and generates the required pressure.

According to another advantageous embodiment of the invention, variations of the fuel mixture amount contained in the fuel circuit are compensated by temporary storage of fuel mixture in a compensation reservoir, which is arranged downstream with respect to the tapping means and before the feed line. Such variations of the fuel mixture amount can arise, for example, due to delays during the pressure adjusting.

According to an advantageous improvement of this embodiment, the fuel mixture in the compensation reservoir is vented, so that the pressure connection between the mixture flowing out of the compensation reservoir and the fuel pump is interrupted. Thus, besides the venting, in this way, a defined pressure reference point is determined, which makes independent of conditions in an already existing fuel circuit.

According to another improvement, the compensation reservoir can be provided with a control device, which, by controlling the fuel mixture amount flowing out of the compensation reservoir, adjusts a determinable fuel mixture volume in the compensation reservoir. Such a control ensures, on the one hand, that always a sufficient amount of liquid is stored to compensate a variation to the bottom, and prevents, on the other hand, the compensation reservoir from being filled up and, thus, renders impossible a variation to the top.

According to another embodiment of the invention, the mixer is arranged between the feed line and the fuel pump. The arrangement within the fuel circuit ensures that circulating fuel mixture is mixed again and again in the mixer, thus preventing a gradual segregation of mixture of fuel and water.

According to another improvement of the invention, the mixer has essentially the shape of a hollow cylinder, in which two mixing chambers being arranged after each other are separated from each other by a flow resistance. Each mixing chamber is assigned to an injection valve, through which water and/or emulsifying agent in radial direction is injectable into the respective mixing chamber. In this operation, the emulsifying agent mixing chamber is arranged, seen downstream, before the water mixing chamber. It has been shown that with such an arrangement of two mixing chambers a particularly good and lasting thorough mixing of fuel with water can be reached.

In another preferred embodiment of the invention, the metering device for metering the volume flow of the fuel being supplied to the fuel circuit is constructed as rotary-piston meter. Such a rotary-piston meter known per se has the advantage that in that manner counting impulses are generated, which can be converted directly, by means of a simple circuit, into corresponding cycle impulses for the injection valves. Such a rotary-piston meter also allows a very exact measurement at low resistance to flow.

In another preferred embodiment of the invention, the feed line is essentially constructed as through conduit having an input end and an output end, into which a socket with an angle being smaller than 90° opens at the side. The input end is, in this method, connected to the metering device, the output end is connected to the suction side of the fuel tank and the socket is connected to the pressure side of the fuel pump.

According to another preferred embodiment of the invention, a heating device is provided, with which at least a part of the fuel circuit and/or tanks provided for storage of the water and the emulsifying agent are heatable. The heating device allows a preheating of the fuel circuit and/or the tanks at low ambient temperatures, already before starting the combustion engine and, thus, guarantees a trouble-free operation and cold start. The heating device can be connected until the optimal operation temperature of the fuel circuit is reached.

The current invention is applicable to any type of combustion systems. Not only internal combustion engines such as diesel or gasoline engines may be improved thereby, but also other types of combustion systems, such as burners of heating furnaces.

Further features and advantages of the invention can be seen from the subsequent description of a preferred embodiment with reference to the drawings.

### SHORT DESCRIPTION OF THE DRAWINGS

FIG. 1 shows an add-on set according to the invention before insertion into a common fuel circuit shown below in a schematic representation;

FIG. 2 shows the fuel circuit from FIG. 1 after insertion of the add-on set;

FIG. 3 shows a graph, which shows the connection between the number of the injection cycles and the number of the counting impulses generated by a rotary-piston meter;

FIG. 4 shows a vertical section through a mixer of the invention in simplified representation;

FIG. 5a shows a vertical section through a compensation reservoir according to the invention in simplified representation; and

FIG. 5b shows the compensation reservoir from FIG. 5awith a higher fill level;

FIG. 6 shows a schematic section of a feed line, which is part of a device according to the invention.

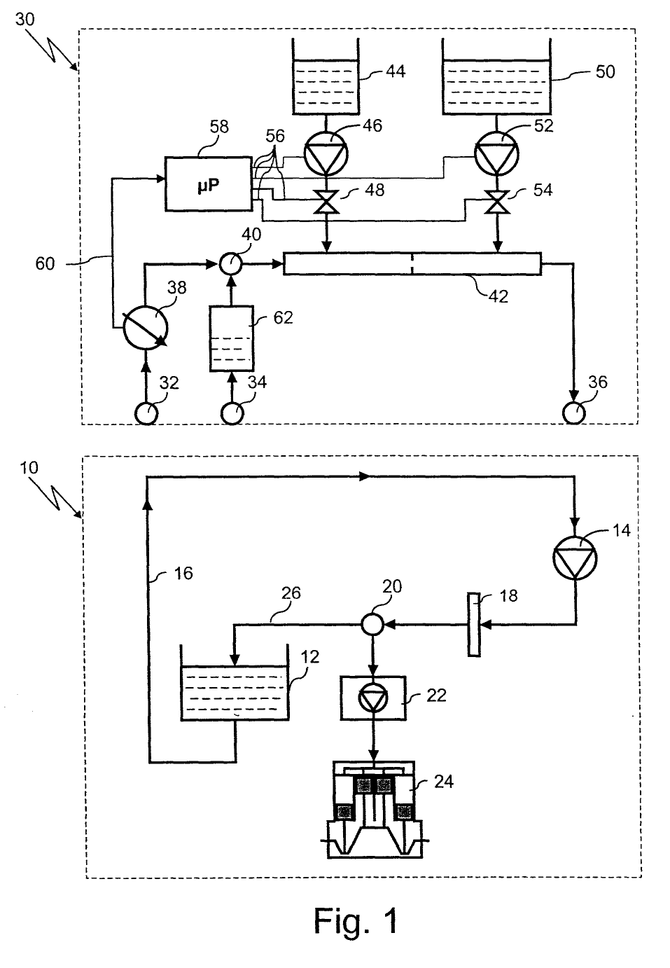

FIG. 1 shows, at its bottom half, a common fuel circuit for a combustion system, in particular a combustion engine, which is designated altogether with 10. The combustion system may also be a burner of a heating furnace or the like. In a fuel tank 12, fuel is contained, which can be, for example, diesel fuel or gasoline. Fuel is pumped by a fuel pump 14, through a fuel pipe 16, out of the fuel tank 12 and is supplied into a tapping means 20 via a fuel filter 18.

Tapping means 20 takes off a part of the circulating fuel out of fuel circuit 10 and supplies it to a consumer 22. Tapping means 20 can be a simple T-piece, it can also be, however, combined with fuel filter 18 to a unity. Depending on the type of combustion system, consumer 22 can be configured e.g. as a carburetor or as an injection pump. The fuel, which remains, after the tapping at tapping means 20, is conducted back through a return path into fuel tank 12. The relationship between the fuel volume flow taken off and the fuel volume flow conducted back into fuel tank 12 depends on the current consumption of combustion engine 24.

Fuel pump 14 is usually constructed in such a way that it produces a constant fuel mixture volume flow. In that way, even when the fuel consumption of combustion engine 24 increases, due to a load increase, up to its maximum value in short time, consumer 22 has, without delay, enough fuel at its disposal. When the load is low, in particular during idle gear of the combustion engine, only a small amount of fuel is taken off from fuel circuit 10 by tapping means 20. The volume flow through return path 26 is then approximately as high as the volume flow through fuel pipe 16.

The add-on set shown in FIG. 1 and designated with 30 comprises three connections 32, 34 and 36, which can be e.g. the ends of pipe sections. Connection 32 is provided for being connected to fuel pipe 16 of fuel circuit 18. At connection 32, a metering device 38 for metering volume flows is adjoined, which can be e.g. a rotary-piston meter of known type. Metering device 38 is connected, via a feed line 40, to a mixer 42, the outlet of which is connected to connection 36.

Mixer 42, the construction of which will be explained in more detail further below, has two mixing chambers, into which emulsifying agent and water can be injected. For this purpose, an emulsifying agent tank 44 is provided, which is connected, via an emulsifying agent pump 46, to an emulsifying agent injection valve 48. By means of emulsifying agent injection valve 48, an exactly definable amount of emulsifying agent can be injected into the first chamber, seen downstream, of mixer 42. For the storage of water, a water tank 50 is provided, which is connected, via a water pump 52, to a water injection valve 54. By means of water injection valve 54, water can be injected into the second mixing chamber of mixer 42. The two injection valves 48 and 54 and pumps 46 and 52 are, respectively, connected via control lines 56 to a control device 58. Moreover, via a further control line 60, metering signals from metering device 38 can be supplied to the control device 58.

Connection 34 is connected to feed line 40 via a compensation reservoir 62, the construction and function of which is explained in more detail further below. The feed line is, in the simplest case, a simple T-piece, in which the volume flows coming from connections 32 and 34 flow together in an angle of 90°. It is preferred, however, to construct feed line 40 according to FIG. 6 as a through conduit 64, the input end 65 of which being connected to the pipe coming from metering device 38 and the output end 66 of which being connected to mixer 42, wherein the pipe coming from compensation reservoir 62 via a socket 67 with an angle α, which is preferably smaller than 90° and can be e.g. in a range of between approximately 60° and 89°, opens into at the side. Both the through conduit and the socket opening into at the side have preferably the same inside diameter.

When inserting add-on set 30 into the existing fuel circuit 18, fuel pipe 16 is, first of all, cut open at a short distance of fuel pump 14. The open end of fuel pipe 16 connected to fuel tank 12 is connected to connection 32 of the add-on set, so that fuel tank 12 is now connected to metering device 38. The other end of fuel pipe 16 being connected to fuel pump 14 is connected to connection 36. Furthermore, return path 26 is interrupted and the open end being connected to tapping means 20 is connected to connection 34.

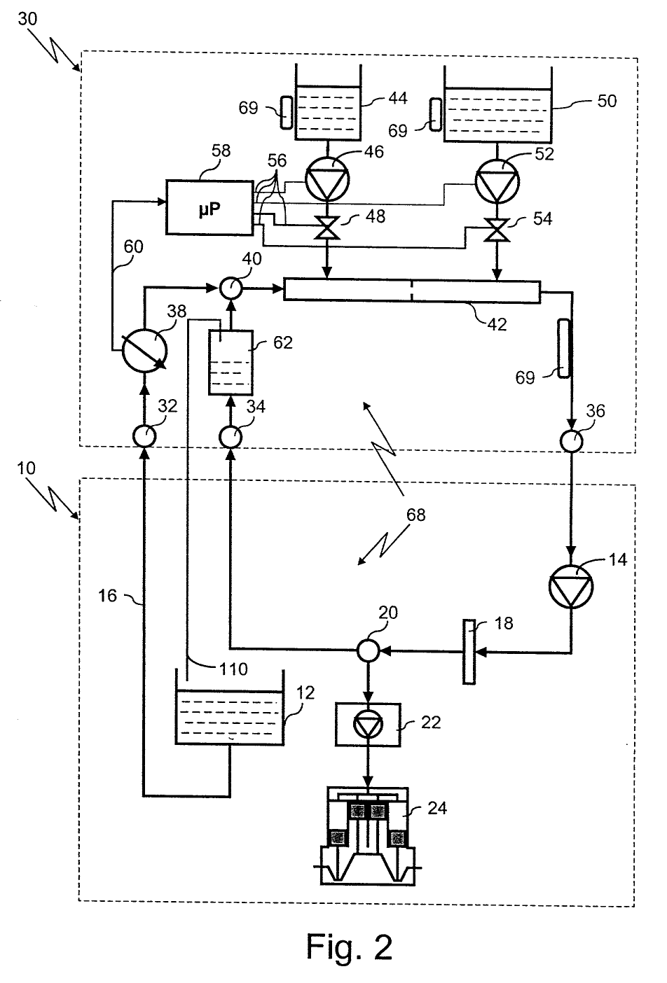

By these meters, fuel tank 12 is taken out of fuel circuit 18, while compensation reservoir 62, feed line 40, as well as mixer 42 are now parts of the fuel circuit. The fuel circuit being modified in that way is, in the following, designated as 68 and shown in FIG. 2.

The function of the method according to the invention is now explained assuming that fuel circuit 68 already contains a mixture of fuel, water and emulsifying agent, wherein, for an initial state, it can be proceeded from pure fuel in the fuel circuit.

Fuel pump 14, in the following designated as mixture pump, circulates the fuel mixture in fuel circuit 68. Mixture pump 14 produces, in this procedure, as before in fuel circuit 18, a constant fuel mixture volume flow. Mixture pump 14 pumps the fuel mixture through fuel filter 18, which should be preferably a metal filter, as paper filters swell due to the water share in the mixture and, thus, cannot be used any more. If, thus, in previous fuel circuit 18 a paper filter was used, it is to be exchanged against a metal filter when inserting add-on set 30.

At tapping means 20, exactly as in previous fuel circuit 18, the fuel mixture volume flow required by consumer 22 is taken off from fuel circuit 68. This volume flow is generally dependent on a plurality of engine parameters such as speed, engine temperature etc. and is not known to control device 58. The remaining volume flow, i.e. the volume flow that was not taken off from tapping means 20, arrives, via connection 34, at feed line 40, wherein here, for the sake of simplicity, compensation reservoir 62 not being essential for the basic principle of the method is thought as to be replaced by a straight piece of hose.

Since fuel mixture was taken off at tapping means 20, the same amount of fuel mixture is not available any more at feed line 40, which was supplied to mixture pump 14 on the suction side. As mixture pump 14 strives, however, to produce a constant fuel mixture volume flow, vacuum arises in fuel circuit 68 on the suction side of mixture pump 14. This vacuum causes fuel to be drawn out of fuel tank 12 via fuel pipe 16 and metering device 38 and to arrive, via feed line 40, in fuel circuit 68. In this procedure, metering device 38 meters the fuel volume flow passing through it.

The metering signals produced by metering device 38 arrive, via control line 60, at control device 58. This 58 now pilots valves 48 and 54, whereby emulsifying agent and water arrive in the mixing chambers of mixer 42. The ratio between the amount of the fuel supplied to fuel circuit 68, of the injected emulsifying agent and of the injected water is, in this procedure, equal to the desired mixture ratio of the three components in the fuel circuit. This ratio is usually fixedly determined, so that the control device needs merely to know the amount of the actually supplied fuel to determine the amounts of emulsifying agent and water to be added.

As the volume of the liquid amount injected in each injection operation is constant, the piloting of valves 48 and 54 can be performed in cycles. For this purpose, it is merely necessary that it is determined in control device 58 how many injection cycles for water and/or for emulsifying agent for a certain fuel volume flow are required.

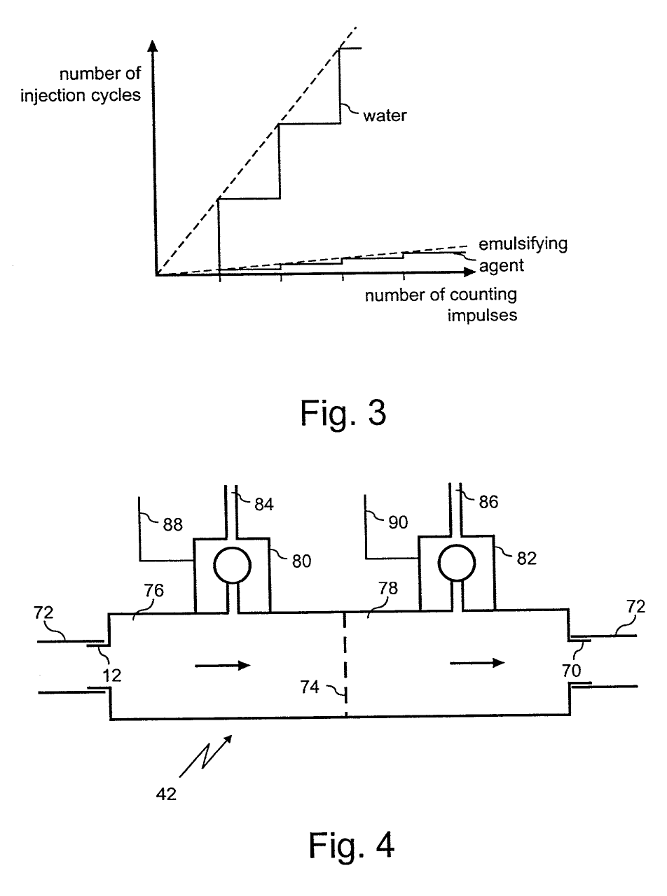

FIG. 3 shows a graph, which shows this connection between the number of injection cycles and the number of counting impulses being generated by a rotary-piston meter metering the fuel volume flow. As the rotary-piston meter generates discrete counting impulses, step functions result for the cycle numbers. The graph shows by means of dashed lines that the connection between the cycle numbers is proportional, i.e. a multiplication of the counting impulses always results in a corresponding multiplication of the cycle numbers. The mixture ratio between water and emulsifying agent in the fuel mixture corresponds here to the ratio of inclinations of dashed lines and is, due to the proportionality talked about, independent of the number of counting impulses and, thus, independent of the supplied fuel amount.

By the feed of fuel at feed line 40 and by the feed of emulsifying agent and water in mixer 42, the decrease in pressure on the suction side of mixture pump 14 is reduced. In this procedure, exactly the amount of fuel is taken off from fuel tank 12 in a self-controlling manner, which, together with the injected emulsifying agent and water, corresponds to the amount of fuel mixture, which was previously taken off from tapping means 20.

The function was described above, for better representation, in a sequence of single steps influencing each other. In real operation of the device, however, these processes occur almost simultaneously, so that even when there are variations in the volume flow taken off at the tapping means, always immediately the corresponding amount of fuel, emulsifying agent and water is added to the fuel circuit, without an external control being necessary. Due to the constant fuel mixture volume flow being produced by mixture pump 14 in fuel circuit 68, it must always be added so much fuel, emulsifying agent and water to the fuel circuit that the amount of fuel mixture taken off is compensated. The right ratio of added fuel, emulsifying agent and water is, in this procedure, according to the invention, determined by metering the amount of added fuel and by selectively adjusting the amount of added emulsifying agent and water.

In order to guarantee a trouble-free function even at low ambient temperatures, an additional heating device is provided, which comprises several heaters 69, which can be arranged, for example, near emulsifying agent tank 44, near water tank 50 and within fuel circuit 68. Heaters 69 are, via control lines that are not shown in FIG. 2, connected to control device 58, which controls fuels 69 in dependency of the ambient temperature and/or of the temperature of the fuel mixture.

FIG. 4 shows in a simplified schematic sectional representation the construction of mixer 42. Mixer 42 has essentially the form of a hollow cylinder, the longitudinal sides facing each other being provided with connecting sockets 70, via which mixer 42 can be connected to corresponding hoses or pipe lines 72. In the inner part of mixer 42, vertically to the longitudinal direction, a dividing wall 74 is arranged, which divides the inner part of the hollow cylinder in two mixing chambers 76 and 78. Dividing wall 74 is provided with several openings and acts, in this manner, as a flow resistance for a liquid flow indicated by the arrows in FIG. 4. Experiments have shown that mixing chambers 76 and 78 should have a volume as small as possible as, then, a particularly homogenous mixture can be reached. On the other hand, mixing chambers 76 and 78 must be large enough to contain the amount of emulsifying agent and water, which are injected into mixing chambers 76 and 78 by injection valves 80 and 82 being arranged on the cylindrical walls of both mixing chambers 76 and 78.

Both injection valves 80 and 82 can, separated from each other, be piloted via control lines 88 and 90 and they are, respectively, constructed in such a way that they inject, in each injection operation, the same amount of liquid into the respective mixing chamber 76 or 78, if the liquid is supplied to the valve at constant pressure via feed lines 84 and 86.

Pumps 46 and 52 which generate a defined constant pressure to both injection valves 80 and 82 are added in order to generate pressure. In this procedure, it is principally sufficient that before each injection operation the respective pump starts shortly and builds up the required pressure. After the injection operation, the respective pump can be switched off immediately. By switching on and off the pumps, it is prevented that the pumps run hot and get damaged after some time.

The pumps can be switched on and off, as just described in the manner that for each injection operation the pump is switched on and off. For a rapid succession of injection operations, this results in a large number of switching on and off cycles. To prevent this, both pumps can be operated in continuous operation, wherein they are merely switched off when the time span between two injection operations exceeds a predetermined threshold. In that way, it is ensured that at least when there is little tapping of fuel mixture, e.g. in idle gear of the combustion engine, the pumps are at least predominantly switched off.

Compensation reservoir 62 allows a certain storage of fuel mixture and a compensation of short-term pressure variations. The fuel mixture emerges from the compensation reservoir with a mostly constant, relatively high pressure so that the emerging mixture can be brought together, via feed line 40, with the fuel coming from the fuel tank. The low pressure acting on the entrance of mixer 42 causes, due to the constant pressure, that, at connection 40, always exactly the part of fuel is supplied from the tank, which, together with the proportionally added water and emulsifying agent, corresponds to the volume taken off by consumer 22. The compensation reservoir also provides for a venting of the fuel circuit.

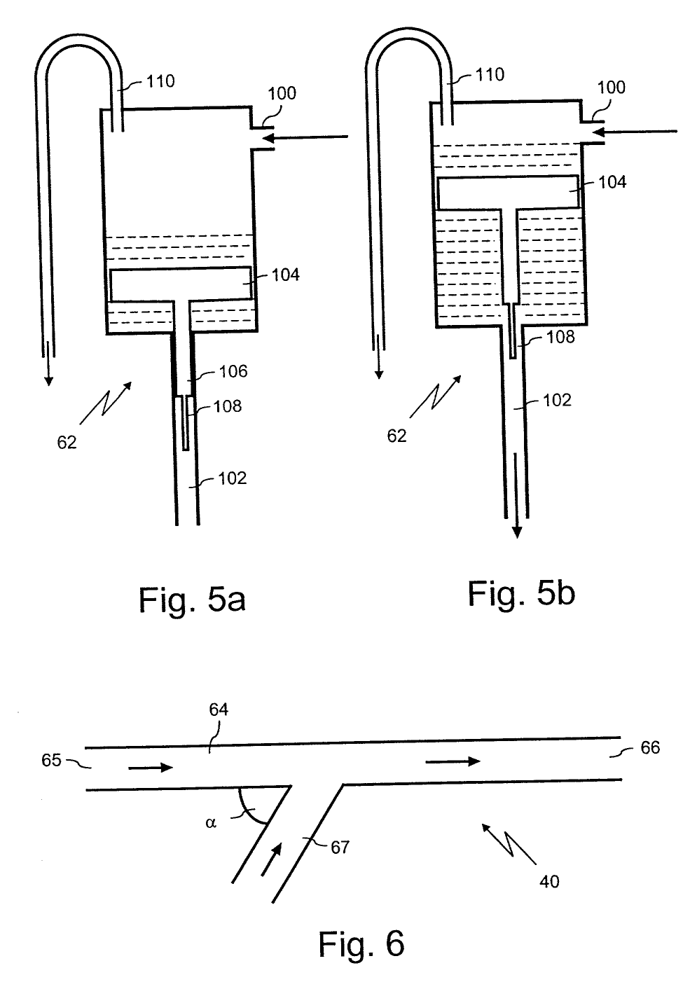

A possible construction for a compensation reservoir is shown in FIG. 5a and 5b. Compensation reservoir 62 consists mainly of a cylindrical container, which is provided, on its top side, with a socket 100 radially showing outwardly. The fuel mixture coming from tapping means 20 flows via socket 100 into compensation reservoir 62. From the center of the floor space of compensation reservoir 62, an outlet 102 opens, over which fuel can flow out of the compensation reservoir to feed line 40.

In compensation reservoir 62 a float 104 is arranged, which rises and sinks together with the liquid level in the container. Between the inner surface of the container and the float a slot remains, so that fuel mixture can pass the float. On its bottom side, float 104 is provided with a projection 106, which transits at its end into a rod 108, the diameter of which is distinctively smaller than the inner diameter of outlet 102.

In the first float position shown in FIG. 5a, projection 106 projects into outlet 104 and locks it nearly completely. Fuel mixture added via socket 100 can, thus, practically not flow off via outlet 102 and is collected, hence in compensation reservoir 62. With increasing liquid level in compensation reservoir 62, float 104 is lifted until, finally, projection 106 releases outlet 102. In this second float position, rod 108, which still projects into outlet 102, ensures that float 104 cannot tip or can only slightly tip over in the container. The fuel mixture can now flow out of outlet 102, wherein float 104 is lowered again bit by bit, until it arrives back in the first float position and locks outlet 102.

At its top end, compensation reservoir 62 is provided with a vent outlet 110, which, as indicated in FIG. 2, can be conducted back into fuel tank 12. Via vent outlet 110, gas bubbles forming in the circulation of the fuel mixture can arrive at the surroundings. Moreover, by means of vent outlet 110, a pressure adjusting is created, so that the fuel mixture flowing out through outlet 102 is subjected only to the hydrostatic pressure being built up in compensation reservoir 62.

The method as such is not impaired by compensation reservoir 62. If float 104 is, for example, in the second float position, i.e. if outlet 102 is open, fuel mixture is drawn out of the container, as long until float 104 finally goes back into the first float position and locks outlet 102. Only then, the vacuum mentioned above is built up at the feed line, due to which the fuel is drawn out of fuel tank 12.

A device according to the invention was realized on the basis of an existing fuel circuit, with which, initially, a diesel engine of a motor vehicle was supplied with pure diesel fuel. Fuel pump 14 of fuel circuit 10 produces a fuel volume flow of 300 ml/min. After inserting add-on set 30, its control device 58 is adjusted in such a way that per volume unit of supplied fuel approximately 0.3 volume units of water and approximately 0.001 volume units of emulsifying agent are added in mixing chamber 42. The fuel mixture being circulated in fuel circuit 68 consists, thus, of approximately 69% of diesel fuel, of 30% of water and of 1% of emulsifying agent. The emulsifying agent consists of a mixture of 60 vol.-% of Disponil 286 and 40 vol.-% of Rilanit GMO. Both Disponil 286 and Rilanit GMO are available from the company COGNIS, Henkelstraβe 67, 40589 Düsseldorf. For the sake of completeness, it should be mentioned that in engines a reversed mixture ratio of both components is preferred.

Due to the fixed injection volume of 0.6 ml, for reaching of the mentioned mixing ratio, water injection valve 54 is consequently up to thirty times more often actuated than emulsifying agent injection valve 48. Mixing chambers 76 and 78 of used mixer 42 each have a volume of 30 ml. Emulsifying agent pump 46 and water pump 52, which are added to the injection valves, each create a pressure of 9 bars. Due to the flow resistance created particularly by fuel filter 18, the fuel mixture is heated in fuel circuit 68 up to approximately 50° C. The maximum fuel volume flow metered by metering device 38 at full load of the diesel engine is 150 ml/min, while in idle gear of the diesel engine this volume flow is decreased to 50 ml/min.

In a test vehicle of type Daimler-Benz 190 D, more than fifteen thousand kilometers were traveled with such an add-on set under a plurality of conditions, wherein a completely trouble-free operation was reached and practically no decrease in performance was observed.

Even after longer outages, a perfect start behavior was reached. This is in particular assigned to the fact that in the fuel circuit a very intensive mixture of the circulating fuel mixture is performed. In particular, however, even when in spite of the addition of emulsifying agent after longer interruptions of the operation a certain segregation of mixture occurs, a sufficient mixture by mixer 42 and fuel filter 18 is guaranteed already at the start process, so that a reliable start is possible even after longer operation interruptions.

It is to be understood that the embodiments mentioned above are variable in many ways. For example, compensation reservoir 62 can be arranged at a different place within fuel circuit 68 or, if possible, be completely omitted. Although an arrangement of mixer 42 between feed line 40 and priming side of mixture pump 14 is preferred, mixer 42 can generally be arranged at another place, e.g. between mixture pump 14 and fuel filter 18. It is also possible to arrange mixer 42 between metering device 38 and feed line 40. An arrangement of mixer 42 within fuel circuit 68 has, however, the advantage that fuel mixture circulating in the fuel circuit is always mixed again and again, so that a segregation of mixture is prevented.

Mixer 42 can, generally, also be combined to a unity with fuel filter 18. Also the injection of emulsifying agent and water needs not necessarily be performed in mixer 42, but can also be performed at another place within fuel circuit 68. Also a feed of water and emulsifying agent between tapping means 20 and consumer 22 is possible, for instance. Most of the alternatives mentioned above, however, cannot or not without problems be realized, if an existing fuel circuit is to be enlarged by means of an add-on set. The invention is, however, not limited to adding-on of existing fuel circuits; rather, the device shown in FIG. 2 can be manufactured as a ready unit and inserted e.g. into motor vehicles.

What is claimed is:

1. A device for producing a fuel mixture for a combustion system, the fuel mixture comprising fuel, water and an emulsifying agent, the combustion system having a fuel circuit forming a loop for circulating the fuel mixture therein, said device comprising:
a fuel pump for circulating the fuel mixture within the fuel circuit in a flow direction;
a tapping means for tapping fuel mixture from said fuel circuit and for feeding said fuel mixture to a consumer;
a mixer having an input and an output arranged within the fuel circuit, the input further communicating with a water tank and communicating with an emulsifying agent tank;
a feed means for feeding fuel into the fuel circuit, said feed means being arranged downstream with respect to said fuel pump and upstream with respect to said mixer;
a fuel tank;
a metering means communicating with the fuel tank and with the feed means for metering the fuel volume supplied out of the fuel tank into the fuel circuit and generating a control signal indicative of the fuel volume supplied into the fuel circuit;
a control means receiving said control signal for controlling the amount of water and emulsifying agent fed into said mixer in accordance with said control signal.

2. The device of claim 1, wherein said said control means is configured for controlling the volumes of the water and emulsifying agent fed into the fuel circuit in proportion to the control signal indicative of the fuel volume flow, thus keeping constant the ratio of fuel, water and emulsifying agent leaving the mixer.

3. The device of claim 2, wherein said mixer comprises a first input communicating with said feed means, a second input communicating with said water tank, and a third input communicating with said emulsifying agent tank.

4. The device of claim 2, wherein said control device is configured for controlling the amount of water and emulsifying agent admixed in said mixer such that per volume unit of supplied fuel 0.2 to 0.4 volume units and 0.005 to 0.015 volume units of emulsifying agent are added.

6. The device of claim 1, further comprising two injection valves, one of which being connected to the input of said mixer and to said water tank, a second one of which being connected to the input of said mixer and to said emulsifying agent tank, both injection valves being controlled by said control device for controlling the liquid volumes injected by said first and second injection valves into the mixer.

7. The device of claim 1, wherein the input of said mixer communicates with said water tank and said emulsifying agent tank, respectively, via a water pump and an emulsifying agent pump, respectively, each of which generating a constant pressure.

8. The device of claim 7, wherein said pumps are configured to generate a pressure of at least 1.5 bars.

9. The device of claim 7, wherein said pumps are configured to generate a pressure of at least 7 bars.

10. The device of claim 1, wherein said fuel circuit further comprises a compensation reservoir having an input end communicating with said tapping device and having an output end communicating with said feed means, said compensation reservoir being configured for compensating short-term pressure variations of the fuel mixture within the fuel circuit.

11. The device of claim 10, wherein said compensation reservoir further comprises a vent outlet connected to said fuel tank.

12. The device of claim 10, wherein said compensation reservoir further comprises a control element for regulating the fuel mixture amount flowing out of said compensation reservoir for keeping a predetermined fuel mixture volume within said compensation reservoir.

13. The device of claim 1, wherein said mixer is arranged in said fuel circuit downstream with respect to said fuel pump and upstream with respect to said feed line.

14. The device of claim 1, wherein th e metering device is configured as a rotary-piston meter.

15. The device of claim 1, further comprising a heating device for heating at least a part of said fuel circuit or for heating at least one of said water and emulsifying agent tanks.

16. The device of claim 1, wherein said fuel circuit further comprises a fuel filter arranged between said fuel pump and said tapping means.

17. The device of claim 1, wherein said combustion system is one of the group formed by a diesel engine, a gasoline engine and a burner.

18. An add-on set configured for installation in a given fuel circuit of a combustion system for producing a fuel mixture comprising fuel, water and an emulsifying agent within said fuel circuit, said add-on set comprising:
a mixer for mixing fuel, water and an emulsifying agent;
a water tank;
an emulsifying agent tank;
a fluid metering means;
fluid lines for connecting the mixer to the given fuel circuit of the combustion system, so as to form a loop comprising the mixer connected via an input and an output thereof, further comprising a fuel pump within the given fuel circuit, and further comprising a tapping means for tapping fuel mixture from the fuel circuit for feeding to a consumer;
fluid lines for connecting the mixer to said water and emulsifying agent tanks;
fluid lines for connecting said fluid metering means to the fuel tank and to the fuel circuit, and for generating a control signal indicative of the fuel volume supplied from said fuel tank into said fuel circuit; and
a control means for controlling fluid flow from said water and emulsifying agent tanks into said mixer in accordance with said control signal.

19. A device for producing a fuel mixture for a combustion system, the fuel mixture comprising fuel, water and an emulsifying agent, said device comprising:
a fuel circuit forming a loop for circulating a fuel mixture therein, said fuel circuit comprising:
a fuel pump for circulating the fuel mixture within the fuel circuit in a flow direction;
a tapping means for tapping fuel mixture from said fuel circuit and for feeding said fuel mixture to a consumer;
a mixer having an input and an output being arranged within the fuel circuit, the input further communicating with a water tank and communicating with an emulsifying agent tank;
a feed means for feeding fuel into the fuel circuit, said feed means being arranged downstream with respect to said fuel pump and upstream with respect to said mixer;
a fuel tank;
a metering means communicating with the fuel tank and with the feed means for metering the fuel volume supplied out of the fuel tank into the fuel circuit and generating a control signal indicative of the fuel volume supplied into the fuel circuit;
a control means receiving said control signal for controlling the amount of water and emulsifying agent admixed into said mixer in proportion to said control signal indicative of the fuel volume flow, thus keeping constant the ratio of fuel, water and emulsifying agent leaving the mixer.

20. The device of claim 19, wherein said combustion system is one of the group formed by a diesel engine, a gasoline engine and a burner.

21. A method for producing a fuel mixture for a combustion system, the fuel mixture comprising fuel, water and an emulsifying agent, the method comprising the following steps:
circulating the fuel mixture in a fuel circuit comprising a fuel pump for producing a fuel mixture volume flow in a flow direction;
tapping fuel mixture from the fuel circuit and feeding to a consumer;
drawing fuel from a fuel tank under the action of vacuum arising from the take-off of fuel mixture and feeding same into the fuel circuit while metering the fuel volume flow fed from the fuel tank into the fuel circuit;
admixing water and an emulsifying agent into the fuel circuit in a mixer in dependence on the fuel volume flow drawn from the fuel tank.

22. The method of claim 21, wherein the volumes of the water and of the emulsifying agent added per time unit are controlled to be proportional to the fuel volume flow metered, so that the ratio of fuel, water and emulsifying agent is kept constant in said fuel circuit.
